(19) United States
(12) Patent Application Publication
(10) Pub. No.: US 2018/0238095 A1
(43) Pub. Date: Aug. 23, 2018

(54) OPENING/CLOSING BODY CONTROL DEVICE

(71) Applicant: KABUSHIKI KAISHA TOKAI RIKA DENKI SEISAKUSHO, Aichi (JP)

(72) Inventors: Takashi NAGAO, Aichi (JP); Tatsushi KATSUYAMA, Aichi (JP)

(73) Assignee: KABUSHIKI KAISHA TOKAI RIKA DENKI SEISAKUSHO, Aichi (JP)

(21) Appl. No.: 15/752,011

(22) PCT Filed: Aug. 16, 2016
(86) PCT No.: PCT/JP2016/073942

§ 371 Date: Feb. 12, 2018

(30) Foreign Application Priority Data
Sep. 3, 2015 (JP) 2015-174057

(51) Int. Cl. E05F 15/46; E05F 15/689; E05F 15/44

(52) U.S. Cl. CPC E05F 15/46; E05F 2015/487; E05F 15/443; E05F 15/689

(57) ABSTRACT

An opening/closing body control device that, when the capacitance of a sensor electrode increases while window glass is ascending, lowers the window glass to prevent pinching. The opening/closing body control device has a disconnection threshold value and a disconnection determination unit. The disconnection determination unit determines whether the sensor electrode is disconnected by comparing the disconnection threshold value and the capacitance of the sensor electrode.

### TECHNICAL FIELD

The present invention relates to an opening/closing body controller that controls movement of an opening/closing body.

### BACKGROUND ART

A known power window device includes an entrapment prevention device that includes a capacitive electrostatic sensor on a window glass and detects an object entrapped by the window glass based on an output from the sensor electrode (refer to patent document 1). When an object approaches or contacts the sensor electrode, the capacitance of a sensor electrode increases. When the capacitance of the sensor electrode becomes greater than or equal to a predetermined value while the window glass rises, the entrapment prevention device lowers the window glass to prevent object entrapment.

### PRIOR ART DOCUMENT

### Patent Document

Patent Document 1: Japanese Laid-Open Patent Publication No. 2005-314949

### SUMMARY OF THE INVENTION

### Problems that are to be Solved by the Invention

The sensor electrode of the power window device needs to detect entrapment of an object by the window glass and is thus usually arranged at the upper end of the window glass. For example, when the window glass reaches the fully-closed position, that is, when the window glass contacts a door frame, impact is applied to the sensor electrode. Further, vibration of a vehicle body is applied to the sensor electrode when the vehicle is traveling. The accumulation of damage resulting from such impact and vibration may break the sensor electrode.

It is an object of the present invention to provide an opening/closing body controller that detects a break in a sensor electrode.

One aspect of the present invention is an opening/closing body controller that compares an entrapment determination threshold value with a detection signal output from a capacitive sensor electrode arranged on an end of an opening/closing body to determine entrapment of an object by the opening/closing body that is moving and reverse or stop movement of the opening/closing body when entrapment is detected. The opening/closing body controller includes a position detector that detects a position of the opening/closing body, a break threshold value used to determine occurrence of a break in the sensor electrode, and a break determination unit that determines the occurrence of a break in the sensor electrode based on the detection signal of the sensor electrode and the break threshold value. When the opening/closing body is located in a region where entrapment determination is not performed, the break determination unit determines the occurrence of a break in the sensor electrode using the break threshold value.

In this configuration, the opening/closing body controller includes the break threshold value used to determine a break in the sensor electrode from the capacitance of the sensor electrode. Thus, the break determination unit monitors a break in the sensor electrode by comparing the capacitance of the sensor electrode with the break threshold value. This allows for detection of a break in the sensor electrode. Further, this configuration performs disconnection determination in the region where entrapment determination is not performed. Thus, the determination of whether to perform entrapment determination or break determination can be switched in accordance with the position of the opening/closing body.

It is preferred that the opening/closing body be moved to close an opening of a metal frame and that the region where the entrapment determination is not performed correspond to a region where the metal frame covers the sensor electrode. In this configuration, when the metal door frame covers the sensor electrode, the metal door frame affects and greatly changes the capacitance of the sensor electrode. In the present embodiment, by performing break determination in the region where the metal door frame covers the sensor electrode, a break in the sensor electrode can be detected when the capacitance is less than the break threshold value without depending on changes in the capacitance that would result from the influence of the door frame. This is advantageous for detecting a break in the sensor electrode with further accuracy.

It is preferred that the region where the entrapment determination is not performed be proximate to where the opening/closing body becomes closed. In this configuration, the region proximate to where the opening/closing body becomes closed is easily affected by the metal door frame. Thus, when the capacitance of the sensor electrode is less than the break threshold value in the region, the sensor electrode is highly likely to have been broken. This is advantageous for detecting a break in the sensor electrode with further accuracy.

It is preferred that the break threshold value be set to be less than a capacitance that is output from the sensor electrode under a situation in which an object is not being detected when the opening/closing body is located in the region where the entrapment determination is not performed. In this configuration, the value of the break threshold value is set to be a suitable value that is necessary for performing break determination.

It is preferred that the break determination unit determine a position where the break has occurred from a value of a capacitance that is output from the sensor electrode. In this configuration, when a break occurs in the sensor electrode, the position where the sensor electrode is broken can be determined.

Some aspects of the present invention detect a break in the sensor electrode. Other embodiments and advantages of the present invention are understood from the following description together with the drawings that illustrate the examples of technical ideas of the present invention.

### BRIEF DESCRIPTION OF THE DRAWINGS

FIG. 1 is a schematic diagram showing a power window device.

FIG. 2 is a block diagram showing the power window device having an entrapment prevention function.

FIG. 3 is a schematic diagram showing the vicinity of a fully-closed position of a window glass.

FIG. 4 is a graph showing the relationship of a position of the window glass and the capacitance when the sensor electrode is not broken.

FIG. 5 is a graph showing the relationship of a position of the window glass and the capacitance when the sensor electrode is broken.

FIGS. 6A and 6B are schematic diagrams showing another example.

### EMBODIMENTS OF THE INVENTION

One embodiment of an opening/closing body controller will now be described with reference to FIGS. 1 to 5.

As shown in FIG. 1, a power window device 1, which is arranged in a vehicle or the like, includes a movable window glass 3, which is an opening/closing body arranged on a door (hereinafter referred to as vehicle door 2), and an actuator 4 that automatically opens and closes the window glass 3. The window glass 3 is, for example, allowed to move straight back and forth between a fully-closed position FC and a fully-open position FO in an opening 6 of a frame (hereinafter referred to as door frame 5). The actuator 4 may include, for example, a motor.

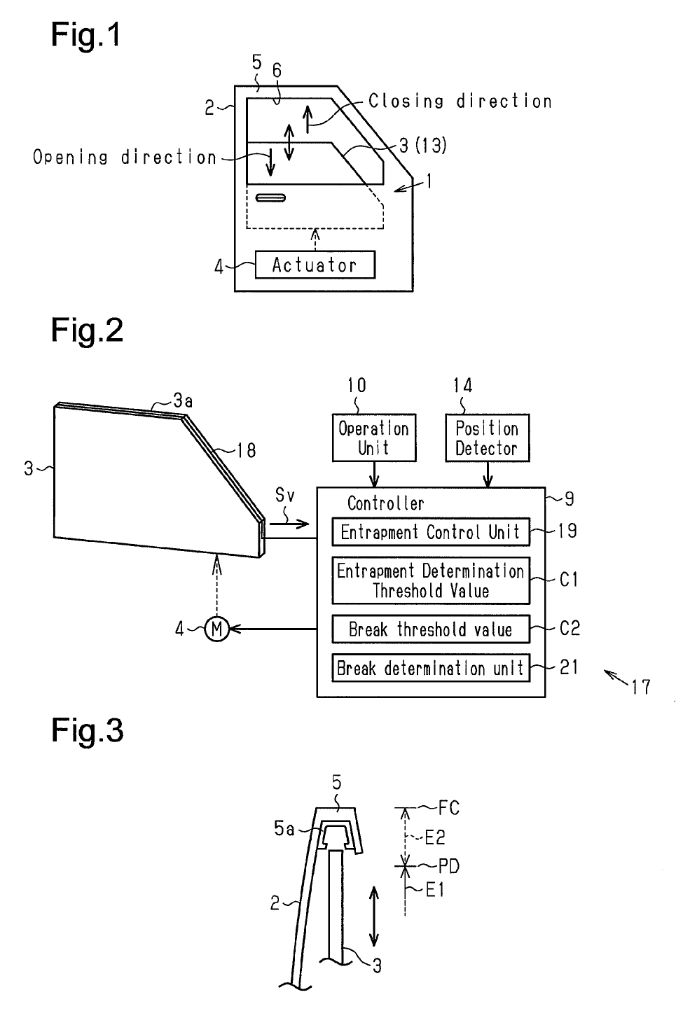

As shown in FIG. 2, the power window device 1 includes a controller 9 that controls the operation of the power window device 1. It is preferred that the controller 9 be, for example, a body electronic control unit (ECU) that manages the power supply of an on-board electric device. The controller 9, which may be a body ECU, can include one or more processors and a software program that is executed by the one or more processors and stored in, for example, a memory. A request signal Sr is input to the controller 9 from an operation unit 10 operated by a user when actuating the power window device 1. The operation unit 10 is arranged in, for example, the vehicle door 2. The power window device 1 can execute manual movement and automatic movement. The manual movement moves the window glass 3 for a period of time during which a user operation is performed on the operation unit 10. The automatic movement moves the window glass 3 to the fully-closed position or the fully-open position when the operation unit 10 is operated. Thus, the request signal Sr includes a manual lifting request signal, a manual lowering request signal, an automatic lifting request signal, and an automatic lowering request signal. The controller 9 provides a drive signal to the actuator 4 to move the window glass 3 up and down in accordance with the request single Sr from the operation unit 10.

The controller 9 is directly or indirectly connected to a position detector 14 that detects the current position of the window glass 3 (for example, current height of upper end 3a of window glass 3). The controller 9 estimates the current position of the window glass 3 based on a position signal Sp provided from the position detector 14. It is preferred that the position detector 14 be, for example, a pulse sensor.

The power window device 1 includes an opening/closing body controller 17 having an entrapment prevention function to prevent entrapment of an object (for example, human body) by the window glass 3. The opening/closing body controller 17 of the present embodiment determines entrapment of an object by the window glass 3 based on a detection signal Sv output from a capacitive sensor electrode 18, which is arranged at an end of the window glass 3, and reverses or stops movement of the window glass 3 when detecting entrapment.

In the present embodiment, the sensor electrode 18 is arranged at the end of the window glass 3 in a closing direction of the window glass 3. In the illustrated example, the sensor electrode 18 is arranged at the upper end of the window glass 3 (entire upper end surface 3a). The sensor electrode 18 detects a capacitance that changes in accordance with the approach of or contact with an object. That is, the sensor electrode 18 can detect an approaching object as well as contact with an object. When an object does not exist nearby, the sensor electrode 18 detects a capacitance having a low value. When an object approaches or contacts the sensor electrode 18, the capacitance becomes high.

The opening/closing body controller 17 includes an entrapment control unit 19 assigned with the entrapment prevention function. The entrapment control unit 19 is arranged in the controller 9. Further, the opening/closing body controller 17 includes an entrapment determination threshold value C1 for an entrapment determination. The entrapment determination threshold value C1 is stored in, for example, a memory (not shown) of the controller 9. The entrapment control unit 19 compares the entrapment determination threshold value C1 with the capacitance (detection signal Sv) that is output from the sensor electrode 18 when the window glass 3 rises. When the capacitance becomes greater than or equal to the entrapment determination threshold value C1, the entrapment control unit 19 determines that entrapment has occurred in the window glass 3 and downwardly reverses the movement direction of the window glass 3 or stops moving the window glass 3 in place.

As shown in FIG. 3, the entrapment prevention function of the present embodiment, for example, determines entrapment when the window glass 3 is in an entrapment determination region E1 between the fully-open position FO and a predetermined height-wise position PD. Entrapment is not determined in the region excluding the entrapment determination region E1, namely, region E2 where entrapment is not determined. Region E2 where entrapment is not determined is a “non-detection zone” where entrapment of an object is not monitored or determined. When the window glass 3 approaches the proximity of the fully-closed position FC and the sensor electrode 18 approaches the door frame 5, which is typically formed from metal, the metal door frame 5 affects and greatly increases the capacitance of the sensor electrode 18. Thus, the entrapment prevention function of the present embodiment is configured not to determine entrapment in region E2, which is proximate to the fully-closed position FC of the window glass 3. This prevents an unintended activation of the entrapment prevention function resulting from the influence of the metal door frame 5 in the proximity of the fully-closed position FC of the window glass 3. It is preferred that when located at the fully-closed position FC, the upper end surface 3a of the window glass 3 indirectly contact the frame 5 by means of a cushion element or an elastic seal element 5a (FIG. 3), which may be formed from rubber. Instead, the upper end surface 3a of the window glass 3 may directly contact the frame 5.

Returning to FIG. 2, the opening/closing body controller 17 has a break detection function to detect a break in the sensor electrode 18. The break detection function of the present embodiment determines that the sensor electrode 18 is broken by monitoring decreases in the capacitance of the sensor electrode 18 based on the factor that the output (capacitance) of the sensor electrode 18 decreases when a conductive sensor electrode 18 is broken.

The opening/closing body controller 17 includes a break threshold value C2 used to determine that the sensor electrode 18 is broken. It is preferred that the break threshold value C2 be stored in, for example, a memory (not shown) of the controller 9.

The opening/closing body controller 17 includes a break determination unit 21 that determines the occurrence of a break in the sensor electrode using the break threshold value C2. The break determination unit 21 is arranged in the controller 9. When the capacitance (detection signal Sv) of the sensor electrode 18 is less than the break threshold value C2, the break determination unit 21 determines that the sensor electrode 18 is broken. Further, when the window glass 3 is located in region E2 where entrapment is not determined, the break determination unit 21 of the present embodiment determines the occurrence of a break in the sensor electrode using the break threshold value C2. It is preferred that region E2 where entrapment is not determined, that is, the region where a break in the sensor electrode is detected, be a region where the metal door frame 5 covers the window glass 3, in other words, a region proximate to where the window glass 3 is closed.

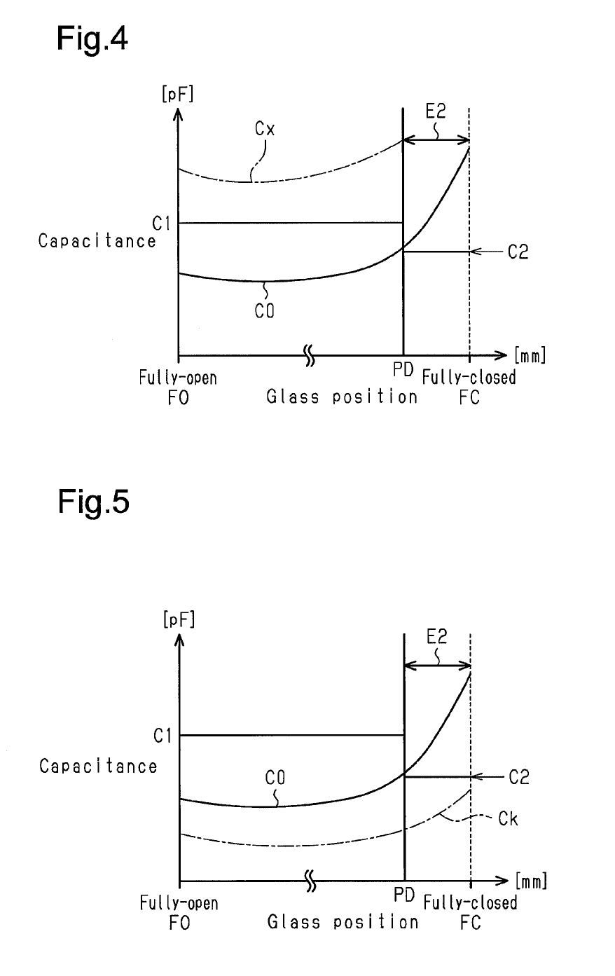

The operation of the power window device 1 (entrapment prevention function and break detection function) will now be described with reference to FIGS. 4 and 5.

As shown in FIG. 4, when an object does not approach or contact the sensor electrode 18, an output “C0” (capacitance) of the sensor electrode 18 is a value “C0” that is less than the entrapment determination threshold value C1. The capacitance “C0” of the sensor electrode 18 is greater than the entrapment determination threshold value C1 in region E2 because the metal door frame 5 affects the capacitance “C0” of the sensor electrode 18 as described above. The capacitance “C0” when an object does not approach or contact the sensor electrode 18 is set whenever, for example, the power supply of a vehicle goes on.

When the window glass 3 moves in the opening direction from the fully-closed position FC, as long as an object does not approach or contact the sensor electrode 18, the output (capacitance) of the sensor electrode 18 gradually decreases. That is, as the window glass 3 opens, the sensor electrode 18 gradually moves away from the metal door frame 5. Thus, the capacitance decreases as the distance increases between the sensor electrode 18 and the door frame 5.

When an open window glass 3 starts to move (rise) in the closing direction and an object approaches or contacts the sensor electrode 18 (upper end 3a of window glass 3), the capacitance of the sensor electrode 18 increases to “Cx.” For example, when part of a human body approaches or contacts the sensor electrode 18, the output of the sensor electrode 18 is affected and increased by the human body. When the window glass 3 rises and the entrapment control unit 19 determines that the capacitance of the sensor electrode 18 has become greater than or equal to the entrapment determination threshold value C1, the entrapment control unit 19 reverses or stops movement of the window glass 3. This restricts situations in which a finger or the like of a user is entrapped by the window glass 3 when the window glass 3 rises.

In FIG. 5, the broken line shows a change waveform of a sensor output Ck (capacitance) when the sensor electrode 18 is broken. The break threshold value C2 is set to be less than the capacitance “C0” that is output from the sensor electrode 18 under a situation in which an object is not being detected when the window glass 3 is located in region E2 where entrapment is not detected. Break determination does not have to be performed in the entire range of region E2 and may be performed only in a predetermined limited area of region E2.

When the conductive sensor electrode 18 breaks, the sensor electrode 18 opens. Thus, the capacitance of the sensor electrode 18 takes a value “Ck,” which is less than value “C0” when an object does not approach or contact the sensor electrode 18. For example, the full length of the sensor electrode 18 energized by the controller 9 is shortened by the break. This lowers the output of the sensor electrode 18. When determining that the capacitance of the sensor electrode 18 has become less than the break threshold value C2, the break determination unit 21 determines that the sensor electrode 18 is broken. It is preferred that when detecting a break in the sensor electrode 18, the break determination unit 21 use a notification unit (not shown) arranged in the vehicle to notify the user of the break.

Thus, the present embodiment sets the break threshold value C2 to determine the occurrence of a break in the sensor electrode 18. Thus, even if the sensor electrode 18 breaks, the break can be detected. Further, when the window glass 3 is fully closed, the sensor electrode 18 is proximate to the metal door frame 5. This limits the influence of external noise on the capacitance of the sensor electrode 18. For example, when the window glass 3 is fully closed, the capacitance varies slightly. Thus, break monitoring in the proximity of the fully-closed position is advantageous for detecting a break in the sensor electrode 18 in a stable manner.

The present embodiment has the advantages described below.

(1) The power window device 1, which determines entrapment using the capacitance of the sensor electrode 18 arranged in the window glass 3, includes the break threshold value C2 that determines the occurrence of a break from the capacitance of the sensor electrode 18 and monitors the sensor electrode 18 for a break by comparing the capacitance of the sensor electrode 18 with the break threshold value C2. Thus, a break in the sensor electrode 18 is detected in the power window device 1 that determines entrapment from the sensor electrode 18. Accordingly, when a break in the sensor electrode is detected, suitable actions can be taken, such as notification of the break and prohibition of the automatic up operation of the window glass 3.

(2) When the window glass 3 is located in region E2 where entrapment is not determined, the break determination unit 21 determines the occurrence of a break in the sensor electrode using the break threshold value C2. Thus, the determination of whether to perform entrapment determination or break determination can be switched properly in accordance with the position (open/closed position) of the window glass 3.

(3) Region E2 where entrapment is not determined, that is, the region where break determination is performed, corresponds to a region where the metal door frame 5 can cover the sensor electrode 18. When the metal door frame 5 covers the sensor electrode 18, the metal door frame 5 affects and greatly changes the capacitance of the sensor electrode 18. In the present embodiment, by performing break determination in the region where the metal door frame 5 covers the sensor electrode 18, a break in the sensor electrode can be detected when the capacitance is less than the break threshold value C2 without depending on changes in the capacitance that would result from the influence of the door frame 5. This is advantageous for detecting a break in the sensor electrode with further accuracy.

(4) Region E2 where entrapment is not determined, that is, the region where break determination is performed, is a region proximate to where the window glass 3 becomes closed. The region proximate to where the window glass 3 becomes closed is easily affected by the metal door frame 5. Thus, when the capacitance of the sensor electrode 18 is less than the break threshold value C2 in region E2, the sensor electrode 18 is highly likely to have been broken. This is advantageous for detecting a break in the sensor electrode with further accuracy.

(5) The break threshold value C2 is set to be less than the capacitance that is output from the sensor electrode 18 under a situation in which an object has not been detected when the window glass 3 is located in region E2. Thus, the value of the break threshold value C2 is set to be a suitable value that is necessary for performing break determination.

(6) The opening/closing body is the window glass 3 of the vehicle door 2. Thus, when entrapment by the window glass 3 is determined from the output of the sensor electrode 18 arranged in the window glass 3, a break in the sensor electrode 18 can be detected.

The embodiment is not limited to the above structure and may be modified as described below.

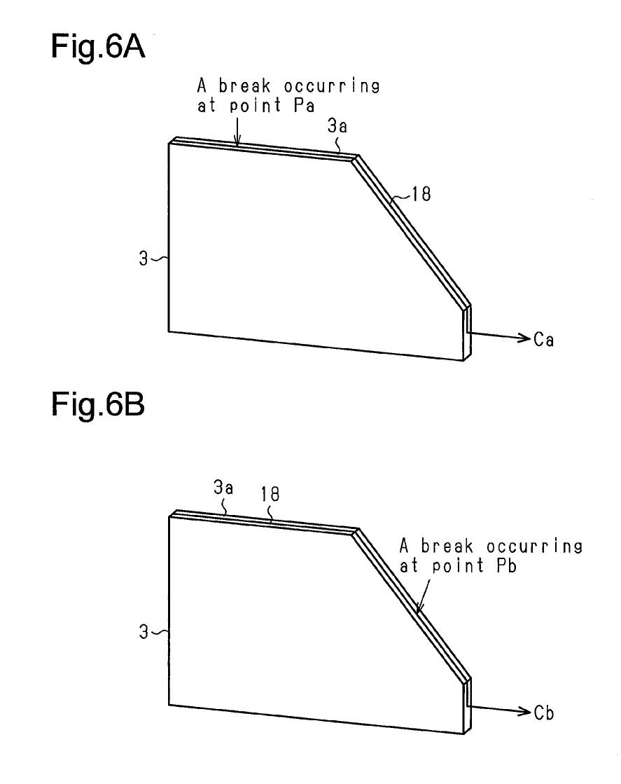

As shown in FIG. 6, the value of the capacitance of the sensor electrode 18 changes in accordance with where a break occurs in the sensor electrode 18. That is, as shown in FIG. 6A, when the sensor electrode 18 breaks at point Pa, the capacitance of the sensor electrode 18 will be “Ca.” As shown in FIG. 6B, when the sensor electrode 18 breaks at point Pb that differs from the point Pa, the capacitance of the sensor electrode 18 will be Cb that differs from Ca. The break determination unit 21 may determine the broken position of the sensor electrode 18 based on the value of the capacitance from the sensor electrode 18 and output a broken position signal. This allows the user to be notified of the position where the sensor electrode 18 is broken.

Region E2 where break determination is performed does not have to be limited to the proximity of the fully-closed position FC of the window glass 3 or to the region where the metal door frame 5 covers the sensor electrode 18 and may be changed to another region.

The break threshold value C2 does not have to be fixed and may be variable. In this case, it is preferred that the entrapment determination threshold value C1 be set in accordance with the current value of a capacitance or the surrounding environment when, for example, the power supply of a vehicle goes on.

Further, the entrapment determination threshold value C1 does not have to be fixed and may be variable.

The sensor electrode 18 may be located at any position on the window glass 3. Further, the length of the window glass 3 may be changed.

The opening/closing body is not limited to the window glass 3 and may be changed to various types of moving opening/closing bodies other than the window glass 3.

The entrapment prevention function of the present embodiment does not have to be applied to a vehicle and is applicable to other devices or equipment such as the door of a building.

The break threshold value C2 may be greater than the capacitance Ck of the sensor electrode 18 taken at any position on the window glass 3 when a break in the sensor electrode occurs but entrapment of foreign matter does not occur. In the illustrated example, the break threshold value C2 may be greater than the capacitance C0 of the sensor electrode 18 when the window glass 3 is located at the fully-open position FO and less than the entrapment determination threshold value C1 when there is no break and no entrapment of foreign matter.

The entrapment determination threshold value C1 and the break threshold value C2 may be stored in different memories of the controller 9 or stored in the same memory of the controller 9. The entrapment control unit 19 and the break determination unit 21 may be allocated to different processors of the controller 9 or allocated to the same processor of the controller 9. For example, the same processor of the controller 9 may function as the break determination unit 21 only when the window glass 3 is located in the break determination region E2 and function as the entrapment control unit 19 only when the window glass 3 is located in the entrapment determination region E1 that differs from the break determination region E2, and the threshold value of the processor may switch between the break threshold value C2 and the entrapment determination threshold value C1 in accordance with the position signal Sp of the position detector 14.

Accordingly, some implementations of the present disclosure provide a controller (9) for use with a capacitive entrapment sensor electrode (18) fixedly attached to an opening/closing body (3), a motor (4) that moves the opening/closing body (3), and a position detector (14) that generates a position signal in accordance with a position of the opening/closing body (3). The controller (9) may include one or more processors (19, 21) and one or more memories accessible by the one or more processors. The one or more memories store a first threshold value (C1), a second threshold value (C2) that differs from the first threshold value (C1), a predetermined boundary position (PD) between a fully-open position (FO) and a fully-closed position (FC) of the opening/closing body (3), and a software program executed by the one or more processors. When executing the software program, the one or more processors (19, 21) are configured to determine entrapment of foreign matter by comparing the first threshold value (C1) with the capacitance of the entrapment sensor electrode (18) included in a detection signal (Sv) output from the entrapment sensor electrode (18) when the opening/closing body (3) is located in an entrapment determination region (E1) between the fully-open position (FO) and the boundary position (PD) while the opening/closing body (3) is closing, determine occurrence of a break in the sensor electrode (18) by comparing the second threshold value (C2) with the capacitance of the entrapment sensor electrode (18) when the opening/closing body (3) is located in a break determination region (E2) between the boundary position (PD) and the fully-closed position (FC) while the opening/closing body (3) is closing, and suspend determination of entrapment of foreign matter when the opening/closing body (3) is located in the break determination region (E2). In some implementations, the one or more processors use the first threshold value (C1) and not the second threshold value (C2) when the opening/closing body (3) is located between the fully-open position (FO) and the boundary position (PD), and the one or more processors use the second threshold value (C2) and not the first threshold value (C1) when the opening/closing body (3) is located between the boundary position (PD) and the fully-closed position (FC). In some implementations, when the opening/closing body (3) is located at the fully-closed position (FC), an upper end (3a) of the opening/closing body (3) directly contacts a frame (5) or indirectly contacts the frame (5) by means of an elastic seal element, and the boundary position (PD) is a position immediately preceding the fully-closed position (FC). In some implementations, the second threshold value (C2) is less than the first threshold value (C1).

The subject matter of the present invention may exist in fewer features than all the features of the particular embodiments and modified examples. The scope of the present invention should be determined with all the scopes of the claims and equivalents.

### DESCRIPTION OF REFERENCE CHARACTERS

2) door (vehicle door); 3) opening/closing body (window glass); 5) frame; 6) opening; 14) position detector; 17) opening/closing body controller; 18) sensor electrode; 21) break determination unit; Sv) detection signal; C1) entrapment determination threshold value; C2) break threshold value; E2) region where entrapment determination is not performed

1. An opening/closing body controller that compares an entrapment determination threshold value with a detection signal output from a capacitive sensor electrode arranged on an end of an opening/closing body to determine entrapment of an object by the opening/closing body that is moving and reverse or stop movement of the opening/closing body when entrapment is detected, the opening/closing body controller comprising:
a position detector that detects a position of the opening/closing body;
a break threshold value used to determine occurrence of a break in the sensor electrode; and
a break determination unit that determines the occurrence of a break in the sensor electrode based on the detection signal of the sensor electrode and the break threshold value,
wherein when the opening/closing body is located in a region where entrapment determination is not performed, the break determination unit determines the occurrence of a break in the sensor electrode using the break threshold value.

2. The opening/closing body controller according to claim 1, wherein
the opening/closing body is moved to close an opening of a metal frame, and
the region where the entrapment determination is not performed corresponds to a region where the metal frame covers the sensor electrode.

3. The opening/closing body controller according to claim 1, wherein the region where the entrapment determination is not performed is proximate to where the opening/closing body becomes closed.

4. The opening/closing body controller according to claim 1, wherein the break threshold value is set to be less than a capacitance that is output from the sensor electrode under a situation in which an object is not being detected when the opening/closing body is located in the region where the entrapment determination is not performed.

5. The opening/closing body controller according to claim 1, wherein the break determination unit determines a position where the break has occurred from a value of a capacitance that is output from the sensor electrode.

6. A controller for use with a capacitive entrapment sensor electrode fixedly attached to an opening/closing body, a motor that moves the opening/closing body, and a position detector that generates a position signal in accordance with a position of the opening/closing body, the controller comprising:
one or more processors; and
one or more memories accessible by the one or more processors, wherein the one or more memories store a first threshold value, a second threshold value that differs from the first threshold value, a predetermined boundary position between a fully-open position and a fully-closed position of the opening/closing body, and a software program executed by the one or more processors,
wherein when executing the software program, the one or more processors are configured to:
determine entrapment of foreign matter by comparing the first threshold value with a capacitance of the entrapment sensor electrode included in a detection signal output from the entrapment sensor electrode when the opening/closing body is located in an entrapment determination region between the fully-open position and the boundary position while the opening/closing body is closing;
determine occurrence of a break in the sensor electrode by comparing the second threshold value with the capacitance of the entrapment sensor electrode when the opening/closing body is located in a break determination region between the boundary position and the fully-closed position while the opening/closing body is closing; and
suspend determination of entrapment of foreign matter when the opening/closing body is located in the break determination region.

7. The controller according to claim 6, wherein the one or more processors suspend break determination when the opening/closing body is located in the entrapment determination region.

8. The controller according to claim 6, wherein
the one or more processors use the first threshold value and not the second threshold value when the opening/closing body is located between the fully-open position and the boundary position, and
the one or more processors use the second threshold value and not the first threshold value when the opening/closing body is located between the boundary position and the fully-closed position.

9. The controller according to claim 6, wherein
when the opening/closing body is located at the fully-closed position, an upper end of the opening/closing body directly contacts a frame or indirectly contacts the frame by means of an elastic seal element, and
the boundary position is a position immediately preceding the fully-closed position.

10. The controller according to claim 6, wherein the second threshold value is less than the first threshold value.
